(19) United States
(12) Patent Application Publication
(10) Pub. No.: US 2017/0294130 A1
(43) Pub. Date: Oct. 12, 2017

(54) RIDER-VEHICLE HANDSHAKE

(71) Applicant: Uber Technologies, Inc., San Francisco, CA (US)

(72) Inventor: Richard Donnelly, Pittsburgh, PA (US)

(21) Appl. No.: 15/094,899

(22) Filed: Apr. 8, 2016

(51) Int. Cl. G08G 1/00; H04W 4/00; H04W 76/02; B60R 16/037; G05D 1/00; B60W 10/18; B60W 10/20; B60W 30/18; H04W 4/02; H04W 12/06

(52) U.S. Cl. CPC G08G 1/202; H04W 4/02; H04W 4/008; H04W 76/023; H04W 12/06; G05D 1/0088; B60W 10/18; B60W 10/20; B60W 30/18; B60R 16/037

(57) ABSTRACT

An autonomous vehicle (AV) and a mobile computing device can perform a rider to vehicle handshake utilizing flash codes received from a backend transport facilitation system. Upon approaching a pick-up location, the AV can output a flash sequence, which can be detected by the mobile computing device to identify the AV to the rider. The mobile computing device may then output a return flash sequence, which can be detected and authenticated by the AV to establish a secure wireless connection with the mobile computing device.

### BACKGROUND

Transport arrangement services can facilitate transportation between available drivers and requesting users. In crowded locations where pick-up request demand is high, difficulties can arise for requesting users in finding their paired vehicles.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example transport facilitation system in communication with user devices and a fleet of AVs, as described herein;

FIG. 2 is a block diagram illustrating an example AV including a control system, according to examples described herein;

FIG. 3A is an illustration showing a mobile computing device and an AV performing a flash code handshake, as described herein;

FIG. 3B is a block diagram illustrating a mobile computing device in communication with a transport facilitation system and an AV, according to examples described herein;

FIGS. 4A through 4C illustrate an example mobile computing device executing a designated application to perform a flash code handshake, as described herein;

FIG. 5A is a flow chart describing an example method of performing a flash code handshake by a mobile computing device, as described herein;

FIG. 5B is a flow chart describing an example method of performing a flash code handshake by an AV, as described herein;

FIG. 6 is a block diagram illustrating a mobile computing device upon which examples described herein may be implemented; and

FIG. 7 is a block diagram illustrating a computer system upon which example AV processing systems described herein may be implemented.

### DETAILED DESCRIPTION

Example service vehicles, autonomous vehicles (AVs), or self-driving vehicles, are provided that can facilitate rider pick-up in, for example, crowded locations. Additionally, example mobile computing devices (MCDs) are provided that can further facilitate in rider pick-up. Such AVs and MCDs can communicate with a backend, transport facilitation system that can connect requesting users with service vehicles, which may comprise human-driven vehicles and/or AVs. Users can launch a designated service application on their mobile computing devices to transmit pick-up requests to the transport facilitation system, which can select vehicles proximate to the respective pick-up locations to facilitate the pick-up requests. In selecting a service vehicle (e.g., an AV or human-driven vehicle), the transport facilitation system can transmit an invitation to service the pick-up request, which can be accepted or refused. Upon accepting the pick-up request, the service vehicle can be driven to the pick-up location to rendezvous with the requesting user.

According to examples described herein, service vehicles (e.g., a fleet of AVs throughout a given region) can each include a outwardly visible lighting element, such as a number or array of LED lights capable of producing rapid flash patterns. For example, the lighting element can be located within the interior and viewable through the front windshield, or can be located on the exterior of the service vehicle. In many aspects, when the service vehicle (or driver of the service vehicle) accepts an invitation to service a pick-up request, the transport facilitation system can transmit a flash code to the service vehicle and the requesting user's mobile computing device. As the service vehicle approaches the pick-up location, the service vehicle can output the flash code using the lighting element. The requesting user can be prompted to hold up the mobile computing device so that a camera or the camera lens of the mobile computing device is pointed towards the service vehicle and detect the flash code, e.g., the camera can be pointed towards the service vehicle and the display screen of the mobile computing device can display a viewfinder or preview of the imagery detected or captured by the camera. Upon detecting the flash code from the service vehicle, the mobile computing device can determine whether the flash code matches the flash code provided by the transport facilitation system (e.g., utilizing a perception algorithm). If so, the mobile computing device can display an indicator, such as a circle or a highlight for the service vehicle, so that the requesting user can readily identify the matched vehicle.

In certain implementations, upon detecting the flash code, the mobile computing device can output a return flash code that the service vehicle can detect to identify the requesting user. For AV implementations, the return flash code can be detected by the AV's sensor array, which can include a number of forward facing stereoscopic cameras. In some aspects, upon detecting the return flash code, the AV can scan for the mobile computing device's media access control (MAC) address in order to automatically establish a secure wireless connection with the mobile computing device (e.g., a Wi-Fi, WiGig, or Bluetooth connection). Upon securing a connection with the AV, the mobile computing device can generate an on-app control system interface to enable the rider to control various adjustable components of the AV, such as the climate control system, the display system, the audio system, and the like.

Among other benefits, the examples described herein achieve a technical effect of facilitating the pick-up process for riders and service vehicles. For example, in crowded environments with high rider demand, the use of flash code authentication described herein can reduce confusion significantly and provide a direct link between a requesting rider and the selected service vehicle (e.g., a matched AV).

As used herein, a computing device refers to devices corresponding to desktop computers, cellular devices or smartphones, personal digital assistants (PDAs), laptop computers, tablet devices, virtual reality (VR) and augmented reality (AR) devices such as VR or AR headsets, television (IP Television), wearable devices, etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

Numerous examples are referenced herein in context of an autonomous vehicle (AV) or self-driving vehicle. An AV and/or self-driving vehicle refers to any vehicle which is operated in a state of automation with respect to steering and propulsion. Different levels of autonomy may exist with respect to AVs. For example, some vehicles may enable automation in limited scenarios, such as on highways, provided that drivers are present in the vehicle. More advanced AVs and self-driving vehicles can drive without any human assistance from within or external to the vehicle.

System Descriptions

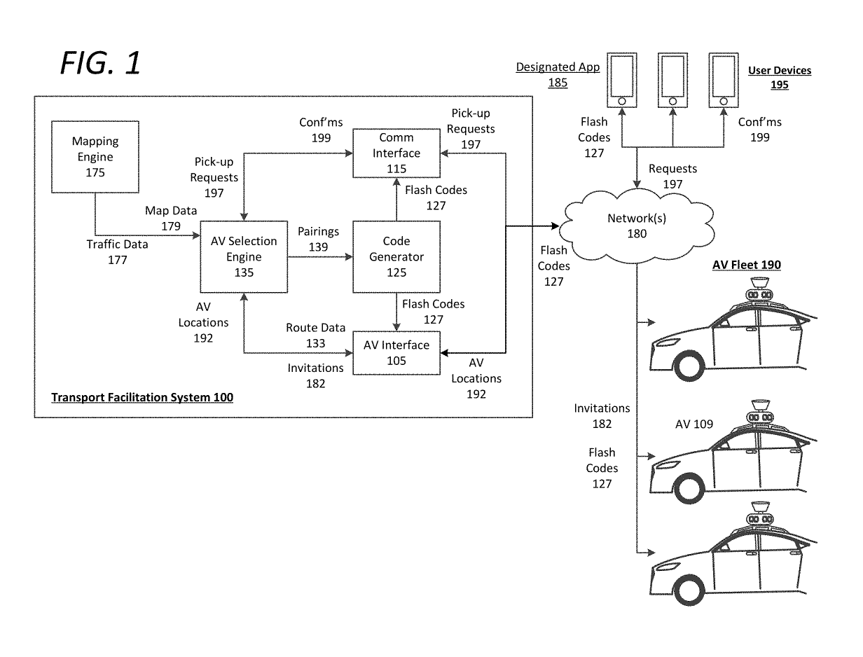

FIG. 1 is a block diagram illustrating an example transport facilitation system in communication with user devices and a fleet of AVs, according to one or more examples. The transport facilitation system 100 can include a communications interface 115 to communicate with the user devices 195 and an AV interface 105 to communication with a fleet of autonomous vehicles (AVs) 190 over a number of networks 180. In addition or in variations, the transport facilitation system 100 can communicate with human drivers operating service vehicles to facilitate transportation in accordance with a transportation arrangement service managed by the transport facilitation system 100. In many examples, the transport facilitation system 100 can provide the transportation arrangement service to link requesting users with service vehicles and/or AVs in the AV fleet 190 managed by the transport facilitation system 100. A designated application 185 corresponding to the transportation arrangement service can be executed on the user devices 195. A requesting user can provide an input on a user device 195 to transmit a pick-up request 197 to the transport facilitation system 100. The pick-up request 197 can be received by the communications interface 115 and sent to a selection engine 135, which can match the requesting user with a proximate AV from the fleet 190.

In one or more examples, the pick-up request 197 can include a pick-up location where a selected AV 109 can rendezvous with the requesting user. In many aspects, the AV 109 can be selected based on a proximity, distance, or time relative to the pick-up location. The fleet of AVs 190 can be dispersed throughout a given region (e.g., a city or metropolitan area) and transmit location data 192 to the AV interface 105 of the transport facilitation system 100. The AV interface 105 can transmit the vehicle locations 192 to the selection engine 135 in order to enable the selection engine 135 to determine candidate vehicles that can readily service the pick-up request 197.

Based on the pick-up location, the locations of proximate AVs in the fleet 190 or other proximate human-driven service vehicles, the selection engine 135 can select a vehicle (e.g., AV 109) to service the pick-up request 197. In certain aspects, the selection engine 135 can further utilize a mapping engine 175 to identify a most optimal vehicle (e.g., AV 109) based on map data 179 (e.g., a distance to the pick-up location) and/or traffic data 177 (e.g., a time to reach the pick-up location). Upon selecting AV 109 as being the most optimal vehicle, the selection engine 135 can transmit an invitation 182 to AV 109 to service the pick-up request 197. In some examples, AV 109 can accept or deny the invitation depending on a number of factors (e.g., remaining fuel or energy, service indicators, owner requirements, etc.). In certain implementations, when AV 109 accepts the invitation 182, the transport facilitation system 100 can utilize the map data 179 and traffic data 177 to provide AV 109 with route information indicating a shortest or most optimal route to the pick-up location. Alternatively, AV 109 may be provided with local mapping resources to identify the most optimal route independently.

After AV 109 accepts the invitation 182 to service the pick-up request 197, the AV selection engine 135 can generate a confirmation 199 for transmission to the user device 195 over the communications interface 115. In one example, the confirmation 199 can include identifying information of the selected AV 109, such as the vehicle type, license plate number, vehicle color, time delta to the pick-up location, and the like. The confirmation information 199 can be displayed to the requesting user via the designated application 185 on a display screen of the user device 195.

In certain situations or scenarios, the confirmation information 199 may not be sufficient in aiding the requesting user to identify the selected AV 109. For example, the requesting user may be unfamiliar with vehicle types, the color of the selected AV 109 may be common (e.g., white), and/or the license plate number may not be readily visible in a crowded pick-up location. Furthermore, several AVs and/or service vehicles may be arriving and departing within a time frame of the selected AV's 109 arrival time at the pick-up location, which can cause confusion regarding which vehicle has been paired with which requesting user.

Accordingly, the transport facilitation system 100 can include a code generator 125 that can generate flash codes 127 based on a particular pairing 139 between a requesting user and a service vehicle or AV. In one example, the code generator 125 generates unique code sets (e.g., flash codes 127) for each rider vehicle pairing. Such unique code sets can include the AV approach code, or initial flash code, an acknowledgement code for the user device 195 to transmit back to the AV 109, and an AV acknowledgment code indicating that the AV 109 has identified or authenticated the acknowledgement code from the user device 109, and/or unique identifiers for the selected AV 109 or user device 195. The flash codes 127 can enable a lighting element (or other output device, such as a radio or acoustic transmitter) on the selected AV 109 to output a unique flash sequence that identifies the selected AV 109 as being matched with the requesting user. As described herein, a flash “sequence” can comprise an outputted pattern of light from one or multiple light sources, and can be comprised of a single or multiple colors and, in certain instances, vary in brightness. When outputted, the flash sequence corresponding to the flash code 127 can be identified using a camera of the requesting user's device 195. By way of the designated application 185, the user device 195 can execute a perception technique to detect the flash sequence outputted by the selected AV 109 as the selected AV 109 approaches the pick-up location, as described in detail below. In response to determining the flash code 127 from the selected AV 109, the user device 195 can display an indicator on the display screen indicating the selected AV 109. In some examples, while the requesting user holds up the user device 195 to detect the flash sequence via the camera, live image data can be displayed on the display screen. Once the specific flash code 127 of the selected AV 109 is detected and authenticated, the user device 195 can display an indicator, such as a circle or a highlight of the selected AV 109 in the live image data.

The code generator 125 can generate one or more flash codes 127 for each pairing 139 made by the AV selection engine 135. In some examples, the code generator 125 can generate a single flash code 127 to be outputted by the selected AV 109 and detected by the requesting user's device 195. In variations, the code generator 125 can generate a pair of flash codes 127 for the pairing 139, such as an initial flash code 127 to be outputted by the selected AV 109 and a return flash code 127 to be outputted by the user device 195 when the initial flash code 127 is detected. According to certain examples, the initial and return flash codes 127 can correspond to an authentication procedure in which the requesting user is not only matched with the selected AV 109, but can also trigger a local wireless connection between the user device 195 and the selected AV 109, as described in detail below.

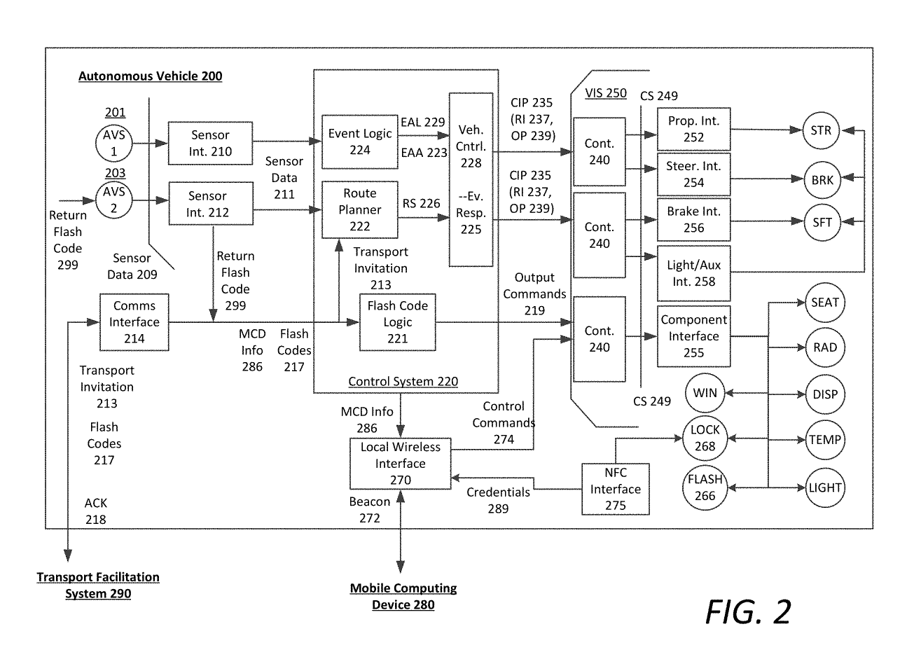

FIG. 2 is a block diagram illustrating an example control system 220 for operating an autonomous vehicle (AV) 200, as described herein. In an example of FIG. 2, a control system 220 can be used to autonomously operate the AV 200 in a given geographic region for a variety of purposes, including transport services (e.g., transport of humans, delivery services, etc.). In examples described, an autonomously driven vehicle can operate without human control. For example, in the context of automobiles, an autonomously driven vehicle can steer, accelerate, shift, brake and operate lighting components. Some variations also recognize that an autonomous-capable vehicle can be operated either autonomously or manually.

In one implementation, the control system 220 can utilize specific sensor resources in order to intelligently operate the vehicle 200 in most common driving situations. For example, the control system 220 can operate the vehicle 200 by autonomously steering, accelerating, and braking the vehicle 200 as the vehicle progresses to a destination. The control system 220 can perform vehicle control actions (e.g., braking, steering, accelerating) and route planning using sensor information, as well as other inputs (e.g., transmissions from remote or local human operators, network communication from other vehicles, etc.).

In an example of FIG. 2, the control system 220 includes a computer or processing system which operates to process sensor data that is obtained on the vehicle with respect to a road segment upon which the vehicle 200 operates. The sensor data can be used to determine actions which are to be performed by the vehicle 200 in order for the vehicle 200 to continue on a route to a destination. In some variations, the control system 220 can include other functionality, such as wireless communication capabilities, to send and/or receive wireless communications with one or more remote sources. In controlling the vehicle 200, the control system 220 can issue instructions and data, shown as commands 235, which programmatically control various electromechanical interfaces of the vehicle 200. The commands 235 can serve to control operational aspects of the vehicle 200, including propulsion, braking, steering, and auxiliary behavior (e.g., turning lights on). In examples described herein, the commands 235

The AV 200 can be equipped with multiple types of sensors 201, 203 which can combine to provide a computerized perception of the space and environment surrounding the vehicle 200. Likewise, the control system 220 can operate within the AV 200 to receive sensor data 211 from the collection of sensors 201, 203, and to control various electromechanical interfaces for operating the vehicle 200 on roadways.

In more detail, the sensors 201, 203 operate to collectively obtain a complete sensor view of the vehicle 200, and further to obtain situational information proximate to the vehicle 200, including any potential hazards proximate to the vehicle 200. By way of example, the sensors 201, 203 can include multiple sets of cameras sensors 201 (video cameras, stereoscopic pairs of cameras or depth perception cameras, long range cameras), remote detection sensors 203 such as provided by radar or LIDAR, proximity or touch sensors, and/or sonar sensors (not shown).

Each of the sensors 201, 203 can communicate with the control system 220 utilizing a corresponding sensor interface 210, 212. Each of the sensor interfaces 210, 212 can include, for example, hardware and/or other logical component which is coupled or otherwise provided with the respective sensor. For example, the sensors 201, 203 can include a video camera and/or stereoscopic camera set which continually generates image data of an environment of the vehicle 200. As an addition or alternative, the sensor interfaces 210, 212 can include a dedicated processing resource, such as provided with a field programmable gate array (“FPGA”) which can, for example, receive and/or process raw image data from the camera sensor.

In some examples, the sensor interfaces 210, 212 can include logic, such as provided with hardware and/or programming, to process sensor data 209 from a respective sensor 201, 203. The processed sensor data 209 can be outputted as sensor data 211. As an addition or variation, the control system 220 can also include logic for processing raw or pre-processed sensor data 209.

According to one implementation, the vehicle interface subsystem 250 can include or control multiple interfaces to control mechanisms of the vehicle 200. The vehicle interface subsystem 250 can include a propulsion interface 252 to electrically (or through programming) control a propulsion component (e.g., an accelerator pedal), a steering interface 254 for a steering mechanism, a braking interface 256 for a braking component, and a lighting/auxiliary interface 258 for exterior lights of the vehicle. According to implementations described herein, control signals 249 can further be transmitted to a component interface 255 of the vehicle interface subsystem 250 to control various components of the AV 200. The vehicle interface subsystem 250 and/or the control system 220 can further include one or more controllers 240 which can receive commands 235 from the control system 220. The commands 235 can include route information 237 and operational parameters 239—which specify an operational state of the vehicle 200 (e.g., desired speed and pose, acceleration, etc.). The commands can further include personalization commands 233 to cause the controller 240 to configure a number of adjustable components of the AV 200 via the component interface 255.

The controller(s) 240 can generate control signals 249 in response to receiving the commands 235 for one or more of the vehicle interfaces 252, 254, 255, 256, 258. The controllers 240 can use the commands 235 as input to control propulsion, steering, braking, and/or other vehicle behavior while the AV 200 follows a current route. Thus, while the vehicle 200 actively drives along the current route, the controller(s) 240 can continuously adjust and alter the movement of the vehicle 200 in response to receiving a corresponding set of commands 235 from the control system 220. Absent events or conditions which affect the confidence of the vehicle 220 in safely progressing along the route, the control system 220 can generate additional commands 235 from which the controller(s) 240 can generate various vehicle control signals 249 for the different interfaces of the vehicle interface subsystem 250.

According to examples, the commands 235 can specify actions to be performed by the vehicle 200. The actions can correlate to one or multiple vehicle control mechanisms (e.g., steering mechanism, brakes, etc.). The commands 235 can specify the actions, along with attributes such as magnitude, duration, directionality, or other operational characteristics of the vehicle 200. By way of example, the commands 235 generated from the control system 220 can specify a relative location of a road segment which the AV 200 is to occupy while in motion (e.g., change lanes, move into a center divider or towards shoulder, turn vehicle, etc.). As other examples, the commands 235 can specify a speed, a change in acceleration (or deceleration) from braking or accelerating, a turning action, or a state change of exterior lighting or other components. The controllers 240 can translate the commands 235 into control signals 249 for a corresponding interface of the vehicle interface subsystem 250. The control signals 249 can take the form of electrical signals which correlate to the specified vehicle action by virtue of electrical characteristics that have attributes for magnitude, duration, frequency or pulse, or other electrical characteristics.

In an example of FIG. 2, the control system 220 can include a route planner 222, event logic 224, flash code logic 221, and a vehicle control 228. The vehicle control 228 represents logic that converts alerts of event logic 224 (“event alert 229”) into commands 235 that specify a set of vehicle actions.

Additionally, the route planner 222 can select one or more route segments 226 that collectively form a path of travel for the AV 200 when the vehicle 200 is on a current trip (e.g., servicing a pick-up request). In one implementation, the route planner 222 can specify route segments 226 of a planned vehicle path which defines turn by turn directions for the vehicle 200 at any given time during the trip. The route planner 222 may utilize the sensor interface 212 to receive GPS information as sensor data 211. The vehicle control 228 can process route updates from the route planner 222 as commands 235 to progress along a path or route using default driving rules and actions (e.g., moderate steering and speed).

In certain implementations, the event logic 224 can trigger a response to a detected event. A detected event can correspond to a roadway condition or obstacle which, when detected, poses a potential hazard or threat of collision to the vehicle 200. By way of example, a detected event can include an object in the road segment, heavy traffic ahead, and/or wetness or other environmental conditions on the road segment. The event logic 224 can use sensor data 211 from cameras, LIDAR, radar, sonar, or various other image or sensor component sets in order to detect the presence of such events as described. For example, the event logic 224 can detect potholes, debris, objects projected to be on a collision trajectory, and the like. Thus, the event logic 224 can detect events which enable the control system 220 to make evasive actions or plan for any potential threats.

When events are detected, the event logic 224 can signal an event alert 229 that classifies the event and indicates the type of avoidance action to be performed. Additionally, the control system 220 can determine whether an event corresponds to a potential incident with a human driven vehicle, a pedestrian, or other human entity external to the AV 200. In turn, the vehicle control 228 can determine a response based on the score or classification. Such response can correspond to an event avoidance action 223, or an action that the vehicle 200 can perform to maneuver the vehicle 200 based on the detected event and its score or classification. By way of example, the vehicle response can include a slight or sharp vehicle maneuvering for avoidance using a steering control mechanism and/or braking component. The event avoidance action 223 can be signaled through the commands 235 for controllers 240 of the vehicle interface subsystem 250.

When an anticipated dynamic object of a particular class does in fact move into position of likely collision or interference, some examples provide that event logic 224 can signal the event alert 229 to cause the vehicle control 228 to generate commands 235 that correspond to an event avoidance action 223. For example, in the event of a bicycle crash in which the bicycle (or bicyclist) falls into the path of the vehicle 200, the event logic 224 can signal the event alert 229 to avoid the collision. The event alert 229 can indicate (i) a classification of the event (e.g., “serious” and/or “immediate”), (ii) information about the event, such as the type of object that generated the event alert 229, and/or information indicating a type of action the vehicle 10 should take (e.g., location of object relative to path of vehicle, size or type of object, etc.).

According to examples described herein, AV 200 can include a communication interface 214 to communicate with a backend, transport facilitation system 290, such as the transport facilitation system 100 described with respect to FIG. 1. In response to a pick-up request, the communications interface 214 can receive a transport invitation 213 from the transport facilitation system 290. The transport invitation 213 can indicate a pick-up location at which to rendezvous with the requesting user. The communications interface 214 can transmit the transport invitation 213 to the route planner 222, which can generate route instructions 226 for the vehicle control 228 in order to operate the AV 200 through road traffic to the pick-up location. Furthermore, in response to receiving the transport invitation 213 the control system 220 can either disregard or otherwise refuse the invitation 213, or accept the invitation 213 by transmitting an acknowledgment 218 back to the transport facilitation system 290.

In certain examples, after transmitting the acknowledgement 218, the communications interface 214 can receive a set of flash codes 217 for output when the AV 200 arrives at the pick-up location. The flash codes 217 can be processed by the flash code logic 221, which can generate a set of output commands 219 to cause a flash element 266, to output the flash code 217. In some examples, the flash code logic 221 can also receive input from the route planner 222 to indicate a proximity to the pick-up location. Additionally or alternatively, the flash code logic 221 can implement timing data to determine a specified time or distance (e.g., twenty seconds or fifty meters) relative to the pick-up location in which to execute the output commands 219 to output the flash code 217 via the flash element 266.

In many examples, the flash element 266 (or lighting element) can comprise one or more lights that are outwardly visible in a forward operational direction of the AV 200. For example, the flash element 266 can comprise a strobe light or strobocope (e.g., a xenon flash bulb), one or more LEDs, or other lighting elements operable by the controller 240 via the component interface 255. In some examples, the flash element 266 comprises several color coded emitters to output a specified light pattern that can include a number of parameters, such as a flash pattern, a color pattern, brightness characteristics, and the like. Once the AV 200 approaches the pick-up location (e.g., within fifty meters), the controller 240 can execute the output commands 219 to cause the flash element 266 to output the flash code 217.

In some aspects, the flash codes 217 received from the transport facilitation system 290 can include a return flash code 299 to be outputted by the requesting user's mobile computing device 280, so that the control system 220 can detect the location of the requesting user to make the pick-up. Accordingly, the sensors 201, 203 (e.g., a camera sensor) of the AV 200 can detect the return flash code 299 which can be analyzed by the flash code logic 221. The flash code logic 221 can authenticate the return flash code 299 based on the flash codes 217 received from the transport facilitation system 290, and pinpoint the requesting user amongst a crowd of people.

According to certain implementations, the communications interface 214 can further receive information 286 from the transport facilitation system 290 that identifies the mobile computing device 280, such as a MAC address, a service set identifier (SSID), or other unique identifier. In some aspects, the mobile computing device 280 does not transmit a return flash code 299, but rather transmits or broadcasts its identity (e.g., via a beacon 272) using a wireless communication protocol, such as WiGig, Wi-Fi, cell radio, or Bluetooth. In variations, the AV 200 includes a local wireless interface 270 that can scan for the beacon 272 from the mobile computing device 280, identify the mobile computing device 280 based on the information 286 received from the transport facilitation system 290, and establish a wireless connection with the mobile computing device 280 (e.g., a Bluetooth, Wi-Fi, or WiGig connection). In one example, the mobile computing device 280 outputs a return flash code 299 from its camera light. In response to detecting the return flash code 299, the control system 220 can trigger the local wireless interface 270 to scan for the MAC address of the mobile computing device 280 to initiate the wireless connection. Additionally or alternatively, upon detecting the return flash code 299, the flash code logic 221 can output a confirmation flash code to finalize the handshake procedure.

In variations, examples described herein recognize that increased security standards may be desirable in various situations. Thus, in some aspects, a locking mechanism 268 of the AV 200 can remain engaged until a particular input is received from the mobile computing device 280. For example, after outputting the flash code 217 and wirelessly connecting with the mobile computing device 280, a control interface can be generated on the mobile computing device 280 to enable the requesting user to control various features of the AV 200, as described below. For example, upon establishing the wireless connection with the AV 200, the requesting user can provide inputs on the control interface to, for example, unlock the locking mechanism 268 to enter the AV 200. Additionally or alternatively, the requesting user can interact with the control interface to make adjustments to, or otherwise configure, various controllable systems of the AV 200, such as the seats, the radio or audio system, a display system of the AV 200, a climate control system, an interior lighting system, the AV's windows, and the like.

In accordance with examples described herein, the handshake procedure between the AV 200 and the mobile computing device 280 can be facilitated by the transport facilitation system 290, which can provide the AV 200 with a device identifier (e.g., a MAC address) of the mobile computing device 280, as well as the flash codes 217, to enable the secure handshake. Accordingly, the local wireless interface 270 can perform a scan of local wireless devices for the specific mobile computing device 280 identified in the information 286 received from the transport facilitation system 290. Thus, the handshake procedure utilizing unique flash code exchanges and targeted scan provides a secure wireless connection (e.g., a Bluetooth or WiGig connection) via the local wireless interface 270.

In one example, the AV 200 can include a near-field communication (NFC) interface 275. Upon performing the flash code handshake, the locking mechanism 268 (e.g., a door lock to a right rear seat or a passenger seat) of the AV 200 can remain locked until the requesting user performs an additional authentication via the NFC interface 275. Accordingly, upon identifying the AV 200 via the flash code 217, the designated application of the mobile computing device 280 can enable a corresponding NFC interface to transmit device credentials (e.g., specific to the mobile computing device 280) over an NFC link with the NFC interface 275 of the AV 200. The NFC interface 275 can be previously configured by the control system 220 based on the unique information 286 of the mobile computing device 280 received from the transport facilitation system 290. Upon receiving the device credentials 289 (e.g., a unique identifier of the mobile computing device 280) over the NFC link, the NFC interface 275 can authenticate the mobile computing device 280 and automatically unlock the locking mechanism 268 to enable the requesting user to enter the AV 200.

Additionally or alternatively, the authentication by the NFC interface 275 can cause the local wireless interface 270 to establish the wireless connection. Accordingly, the NFC interface 275 can transmit the device credentials 289 to the local wireless interface 270 which can initiate the secure wireless connection with the mobile computing device 280, as described herein. Upon establishing the wireless connection, the mobile computing device 280 can generate the control interface to enable the requesting user to adjust and/or configure the various interior components of the AV 200. In some examples, the NFC interface 275 can be located on a curbside portion of the AV 200, such as above a right-side door. In variations, the NFC interface 275 can be located on one or more doors of the AV 200 (e.g., replacing the door handles or door locks). Thus, when the AV 200 pulls up to pick up the requesting user (after the flash code handshake), the designated application of the mobile computing device 280 can automatically enable the corresponding NFC interface to readily facilitate user ingress into the AV 200. In such examples, the flash code handshake procedure can enable the requesting user and the AV 109 to readily identify each other, and the NFC authenticate can enable user ingress and/or the secure wireless connection via the local wireless interface 270.

In typical vehicles, the interior components (e.g., power windows, audio system, display system, climate control system, etc.) include analog devices that enable users to perform adjustments and configurations, such as selecting a radio station or video content, adjusting the seat, or adjusting the cabin temperature. According to examples described herein, the AV 200 can exclude some or all of the adjustment features (e.g., analog buttons or levers) and enable the user to make such adjustments via the control interface on the user's mobile computing device 280 and the wireless connection with the local wireless interface 270. Thus, user inputs on the control interface can comprise control commands 274 that can be transmitted to the component interface 255 for execution on the configurable and/or adjustable components of the AV 200. More specifically, the user inputs on the control interface can generate control commands 274 to adjust seat positioning and/or temperate, radio settings, display settings or content to be displayed, the AV's climate control system, interior lighting, networked and/or computation service (e.g., virtual reality, augmented reality, conferencing, secure network access, gameplay, etc.), and various other systems such as the windows, a sunroof or moon roof, mirror, and the like. Once the AV 200 arrives at the destination and the user exits, the secure connection can be terminated and the AV 200 can continue receiving transport invitations 213 from the transport facilitation system 290 accordingly.

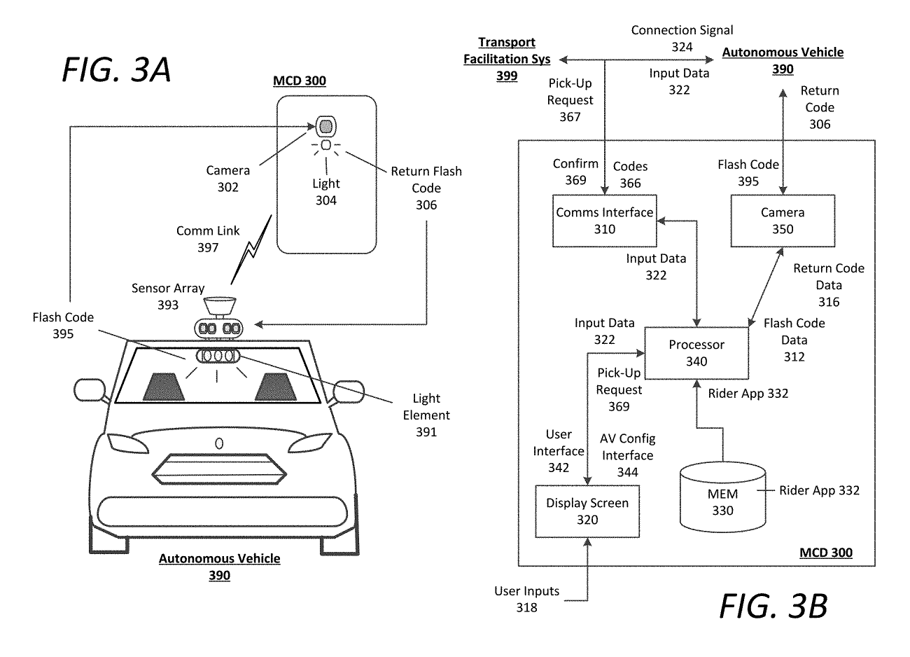

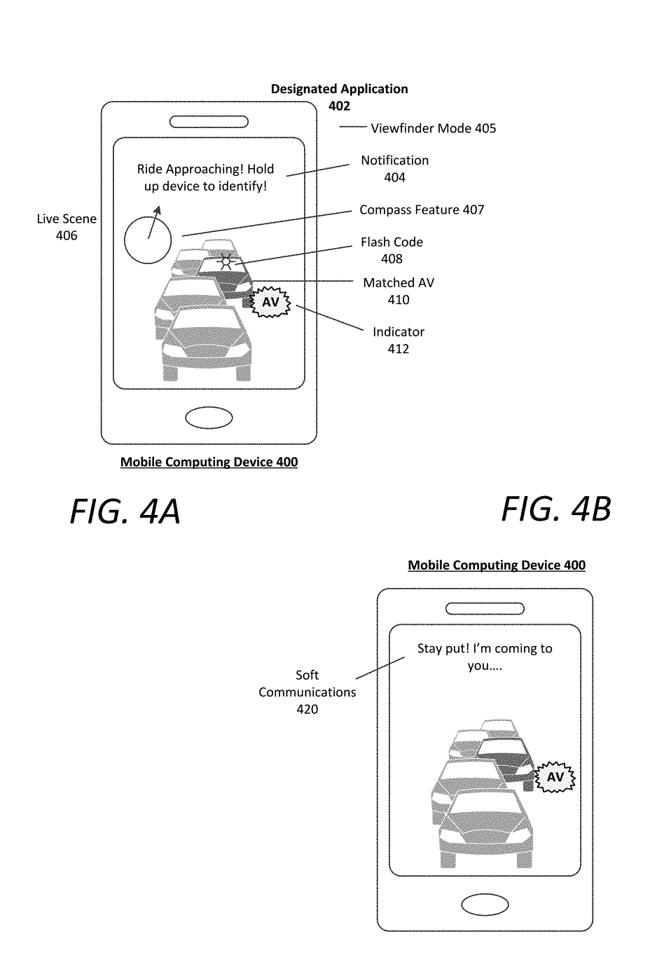

FIG. 3A is an illustration showing a mobile computing device and an AV performing a flash code handshake, as described herein. In the example shown in FIG. 3A, the AV 390 and the mobile computing device 300 have been paired by a backend transport facilitation system 100, 290 as shown and described with respect to FIGS. 1 and 2. Furthermore, the transport facilitation system 100, 290 can transmit unique flash codes to the AV 390 and mobile computing device 300, for example, once the AV 390 accepts the pick-up request from the mobile computing device 300. Still further, the AV 390 can be routed to the pick-up location in order to rendezvous with the requesting user.

Examples described herein recognize that the mobile computing device 300 can be any computing device executing a designated application described herein. For example, the mobile computing device 300 can comprise a smartphone or other cellular communication device, a tablet computer, wearable devices (e.g., wrist worn devices), a virtual reality (VR) headset, an augmented reality (AR) headset that combines virtual elements with a real world environment, and the like.

As the AV 390 approaches, the AV 390 can utilize a lighting element 391, outwardly visible in a forward operating direction, to output an initial flash code 395. Furthermore, as the AV 309 approaches, a user prompt can be generated on the requesting user's mobile computing device 300 that can instruct the user to point a camera 302 of the mobile computing device 300 towards incoming traffic. According to examples described herein, the mobile computing device 300 can execute a viewfinder mode to analyze a live scene for the unique flash code received from the transport facilitation system 100, 290. In some aspects, multiple flash codes from multiple incoming AVs can be perceived by the mobile computing device 300. However, in executing the viewfinder mode, the mobile computing device 300 can analyze and disregard non-matching flash codes from other AVs. Once the matching flash code 395 is identified, the mobile computing device 300 can generate an indication feature viewable on the display so that the requesting user can readily identify the matching AV 390.

In some examples, upon detecting the initial flash code 395, the mobile computing device 300 can initiate a return flash code 306 using a light 304 on the mobile computing device 300. In one aspect, the light 304 can comprise the camera flash light of the mobile computing device 300. The AV 390 may then identify the return flash code 306 using the AV's sensor array 393 to authenticate the requesting user, and identify the user's precise location. In certain implementations, the AV 390 can then establish a wireless connection with the mobile computing device 300 and transmit additional data. For example, in heavy traffic, the AV 390 can transmit a request to the mobile computing device 300 that the user walk towards the AV 390 to enter the AV 390. As another example, the AV 390 can transmit a request for the user walk to a proximate location for pick-up, such as at a street corner or down a side street with less traffic.

Examples described herein refer to a flash code handshake utilizing a light element 391 of the AV 390 and a light 304 of the mobile computing device 300 to output the flash code 395 and return flash code 306 respectively. However, it is contemplated that the initial flash code 395 and/or the return flash code 306 can be outputted utilizing alternative resources of the AV 390 and the mobile computing device 300. For example, the flash code 395 and/or return flash code 306 can be outputted via other transmitting devices, such as radio transmitters outputting the codes in a non-visible frequency band (e.g., radio, infrared, or microwave), acoustic transmitters, and the like.

FIG. 3B is a block diagram illustrating a mobile computing device in communication with a transport facilitation system and an AV, according to examples described herein. In accordance with various implementations described herein, a processor 3400 of the mobile computing device 300 can execute a rider application 332 stored in memory 330. The rider application 332 can provide access to a transportation arrangement service managed by the backend transport facilitation system 399, and upon execution, can generate a user interface 342 on the display screen 320 that enables the user to provide user inputs 318 to transmit a pick-up request 367, via a communications interface 310, to the transport facilitation system 399. Upon matching the mobile computing device 300 with a proximate AV 390, the mobile computing device 300 can receive a confirmation 369 via the communications interface 310 indicating that an AV 390 is en route to the pick-up location. In some examples, the confirmation 369 can be displayed on the display screen 320 to indicate an estimated time of arrival for the AV 390, and can also provide a mapping feature showing the AV's 390 live location as the AV 390 drives to the pick-up location.

In a background process, the mobile computing device 300 can receive unique flash codes 366 from the transport facilitation system 399. In some aspects, the flash codes 366 can include data indicating the flash code 395 that will be outputted by the AV 390. Additionally, the flash codes 366 can include data indicating a return flash code 306 to be outputted by the mobile computing device 300 once the initial flash code 395 is detected. Accordingly, as the AV 390 approaches the pick-up location, a camera 350 of the mobile computing device 300 can detect and verify the flash code 395 from the AV 390. For example, flash code data 312 corresponding to the detected flash code 395 can be analyzed by the processor 340 against the flash codes 366 received from the transport facilitation system 399. In some aspects, when the flash code data 312 is verified, the processor 340 can transmit return code data 316 to the camera 350 to output a return flash code 306 for the AV 390.

Accordingly to some examples, upon receiving and verifying the flash code 395, the mobile computing device 300 can attempt to establish a secure wireless connection with the AV 390. In one aspect, the transport facilitation system 399 can transmit identifier data to the mobile computing device 300 indicating the AV's MAC address in order to establish the connection directly upon authenticating the flash code 395. In variations, the AV 390 can previously receive the MAC address of the mobile computing device 300 from the transport facilitation system 399 (e.g., upon accepting the pick-up request 367) in order to perform a scan for the mobile computing device 300 once the return flash code 306 is authenticated by the AV 390. In either case, once the flash code handshake described herein is finalized, the communications interface 310 can transmit a connection signal 324 to the AV 390 (or vice versa) to establish the secure wireless connection.

Once connection with the AV 390, the rider application 332 can generate an AV configuration interface 344 (or control interface described herein) to enable the requesting user to configure various interior components of the AV 390, as described herein. While the AV 390 transports the user to the destination, the user can provide user inputs 318 on the AV configuration interface 344 to, for example, adjust a seating position, adjust the temperature, configure an audio system, view video content, access network services of the AV 390 (e.g., virtual reality services, games, entertainment content, conferencing services, work settings, etc.), and the like. Input data 322 based on the user inputs 318 on the AV configuration interface 344 comprise control commands to make such adjustments. Accordingly, the mobile computing device 300 can transmit the input data 322 to the AV 390 to implement the user configurations.

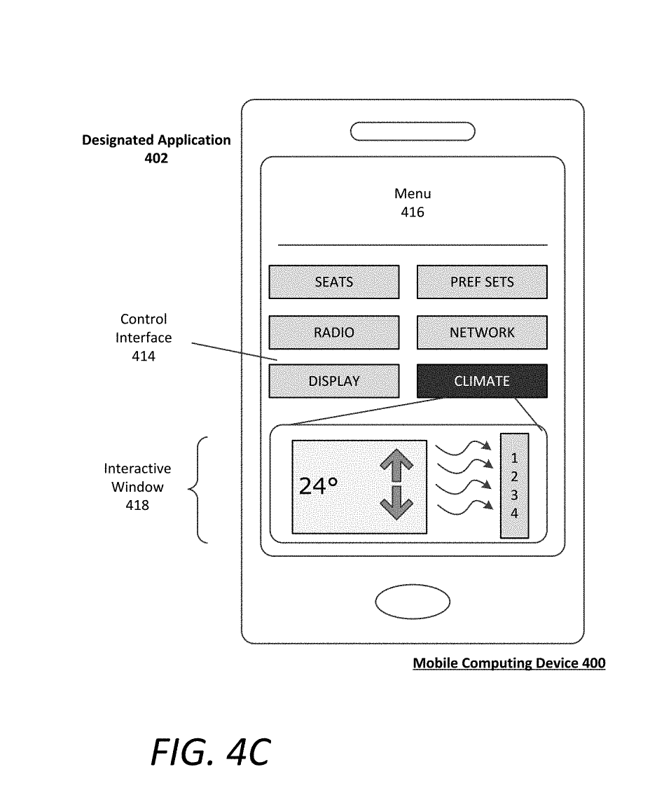

FIGS. 4A through 4C illustrate an example mobile computing device executing a designated application to perform a flash code handshake, as described herein. Referring to FIG. 4A, the user of the mobile computing device 400 can await a matched AV 410 after transmitting a pick-up request and receiving a confirmation from the backend transport facilitation system, as described herein. The mobile computing device 400 can execute the designated application 402 enabling the user to access the transportation arrangement services provided by the transport facilitation system. In many aspects, the mobile computing device 400 can monitor the AV's 410 progress to the pick-up location. Once the AV 410 is within a certain distance or time from the pick-up location, the mobile computing device 400 can further execute a viewfinder mode 405 (e.g., within the designated application 402) to generate a notification 404 indicating that the AV 410 is arriving.

In certain examples, the notification 404 can comprise a push notification that can overlay current content being viewed by the user. Additionally or alternatively, the notification 404 can include a request that the user point the camera of the mobile computing device 400 towards oncoming road traffic. In the viewfinder mode 405, the mobile computing device 400 can also generate a compass feature 407 indicating a direction in which the user is to point the camera of the mobile computing device 400 to detect the flash code 408 from the match AV 410. In certain implementations, the compass feature 407 can be configured based on relative location data between the mobile computing device 400 and the approaching AV 410. Furthermore, in the viewfinder mode 405, the mobile computing device 400 can automatically display (or in response to user input) a live scene 406 showing oncoming vehicles. The matched AV 410 can output a flash code 408, which can be detected by the camera and verified by the mobile computing device 400. Upon verification, the mobile computing device 400 can generate an indicator 412 identifying the matched AV 410 for the user. As the AV 410 pulls up to pick up the user, the mobile computing device 400 can track the AV 410 and generate the indicator 412 to follow the AV 410 on the display screen.

According to certain examples, the live scene 406 can be presented as a gray-scale stream on the display. Once the flash code 408 is detected and authenticated by the mobile computing device 400, the indicator 412 can comprise a colored feature presented to identify the matched AV 410 in the live scene 406. This colored feature can highlight the matched AV 410 in color among the remaining gray-scaled vehicles and scene elements. In some aspects, the mobile computing device 400 can generate the colored feature to represent or overlay the matched AV 410, and can present the AV 410 in the live scene 406 as being brighter that the non-matched vehicles.

Referring to FIG. 4B, while executing the designated application 402, the mobile computing device 400 can receive a connection signal from the AV 410 to establish a secure wireless connection. In one example, the AV 410 can scan the mobile computing device 400 to identify available network protocols for establishing the connection. For example, the user of the mobile computing device 400 may already be using Bluetooth or Wi-Fi, which can cause the AV 410 utilize an alternative network protocol (e.g., cellular radio). In one example, the mobile computing device 400 can provide data to the AV 410 indicating available network protocols on the mobile computing device 400, and the AV 410 can utilize a protocol hierarchy in setting up the network connection. For example, the AV 410 can attempt Wi-Fi first, then Bluetooth, then cellular, etc. If a particular network protocol is unavailable, then the AV 410 can attempt to use an alternate protocol. Additionally or as an alternative, upon entering the AV 410, the rider can physically plug the mobile computing device 400 into an input interface (e.g., a universal serial bus port) of the AV 410 in order to, for example, charge the mobile computing device 400 and/or enable communications and control interface 414 inputs, as described below.

The mobile computing device 400 can exit the viewfinder mode (e.g., via user input or automatically) once the user enters the AV 410 or as the AV 410 approaches. In response to detecting the wireless connection (e.g., Bluetooth, Wi-Fi, WiGig, or cellular radio), or wired connection, the designated application 402 can enable soft communications 420 with the matched AV 410 over the connection. For example, the matched AV 410 can identify traffic or congestion conditions and make a determination of whether the conditions are safe for a rendezvous at the AV's current location, whether the user should meet the AV 410 at an alternative location, or, as shown in FIG. 4B, the user should wait a few moments for the AV 410 to arrive at the user's present location. The AV 410 can transmit and/or receive communications with the mobile computing device 400 indicating, for example, a rendezvous location, which may be inputted by the user or suggested by the AV 410.

Referring to FIG. 4C, when the wireless connection is established, the mobile computing device 400 can generate a control interface 414 on the display screen of the mobile computing device 400. The control interface 414 can enable the rider to make various adjustments to any number of configurable components of the AV 410. In certain aspects, the control interface 414 can include a menu 416 indicating various components such as the seats, windows, audio system or radio, the display (e.g., to view television content), the climate control system, preference sets, door locks, and the network and/or computational services available on the AV 410 (e.g., conferencing, gaming, virtual reality and/or augmented reality features, etc.).

In one aspect, selection of a preference set feature (as shown in FIG. 4C) can cause an interactive window 418 to be generated that enables the user to configure “top level” preferences for the user. Such top level preferences can comprise multiple rider profiles for the user that configure the AV 410 in a certain manner based on the conditions or nature of the AV ride. For example, the user can select a work profile that can shut down the audio system and enable certain features or services paid for by the user's employer. As another example, the user can select a date profile that can configure certain features such as mood lighting, a temperature preference, or a specified song on the audio system. Thus, as the AV 410 approaches or once the user enters the AV 410, the selected top level preferences can be configured based on a single selected feature on the control interface 410.

According to some examples, selection of a particular component on the menu 416 can trigger an interactive window 418 that enables the rider to make adjustments or otherwise configure the selected component. For example, selection of the audio system feature can enable the user to select a radio channel, and adjust the volume and other audio settings. As another example, selection of the network services component can enable the user to set up a video conference, select a game, browse the web, and the like. In the example shown in FIG. 4B, the rider has selected the climate control feature on the control interface 414. The interactive window 418 for the climate control feature can enable the rider to adjust a cabin temperature, fan speed, provide outside air or recirculate cabin air, and the like.

Thus, examples provided herein provide for flash code authentication to not only facilitate in identifying the AV 410, but also to set up a secure connection between the AV 410 and the rider's mobile computing device 400. Utilizing the secure connection, the rider can be provided with a control interface 414 on the rider's mobile computing device 400 via the designated application 402 to allow the rider to interact with the various configurable systems of the AV 410. Accordingly, the traditional adjustment features, such as analog buttons, seat levers or switches, mechanical switches (e.g., door locks and handles), can be excluded from the AV 410 in order to reduce potential failure points on the AV 410. Control signals corresponding to user interactions and inputs on the control interface 414 can be transmitted to a communications interface of the AV 410, and the AV control system can perform the adjustments, settings, and/or configurations to the corresponding systems accordingly.

Methodology

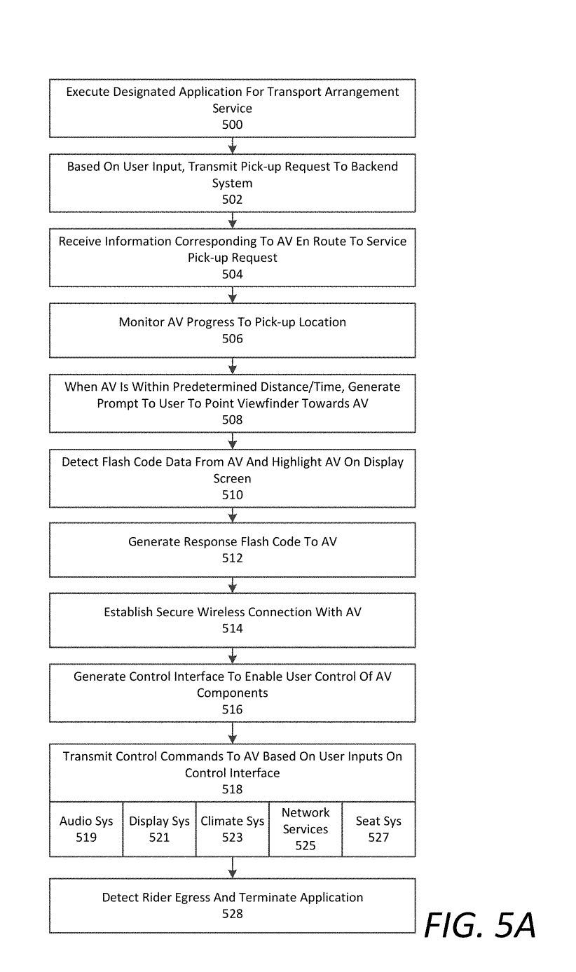

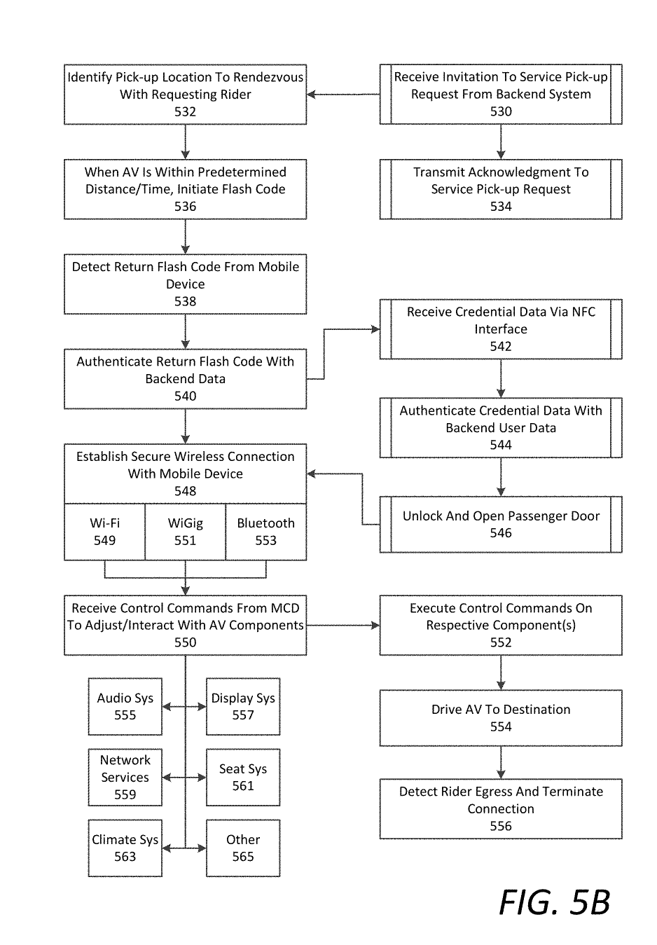

FIG. 5A is a flow chart describing an example method of performing a flash code handshake by a mobile computing device, as described herein. In the below description of FIG. 5A, reference may be made to reference characters representing like features describing in connection with FIGS. 1 through 4B. Furthermore, the method described with respect to FIG. 5A may be performed by an example mobile computing device 300 as shown and described in connection with FIG. 3B. Referring to FIG. 5A, the mobile computing device 300 can execute a designated application for a transport arrangement service provided by a transport facilitation system 399 (500). Based on a user input, the mobile computing device 300 can transmit a pick-up request 367 to the backend transport facilitation system 399 (502). In response, the mobile computing device 300 can receive information corresponding to a selected AV 390 that is en route to service the pick-up request 367 (504). Such information can include a description of the AV 390, such as a badge or license plate number, a vehicle type, a color, and the like. Additionally or alternatively, the information can be dynamic in nature, and can include the AV's location and/or ETA information, such that the mobile computing device 300 can generate a virtual representation of the AV 390 on a generated map to indicate route progress of the AV 390 as it drives to the pick-up location.

According to examples described herein, the mobile computing device 300 can monitor the AV's progress to the pick-up location (506), and when the AV 390 is within a proximity to the pick-up location, such as a predetermined distance or time, the mobile computing device 300 can generate a prompt (e.g., a visual and/or audio prompt) instructing the user to point the camera 350 of the mobile computing device 300 towards oncoming road traffic (508). In many aspects, the mobile computing device 300 can detect flash code data 312 via the camera, and provide a visual indication of the AV 390 on the display screen 320 identifying the AV 390 (510). In one example, the visual indication can comprise a shaped outline, such as a colored circle or square, that identifies the AV 390 on live image data displayed on the display screen 320. Alternatively, the visual indication can comprise a highlight of the AV 390. In such an example, the live image data from the camera can comprise black and white image data, and the mobile computing device 300 can generate a color highlight of the AV 390 in the black and white image data.

In one or more examples, the mobile computing device 300 can then generate and output a response flash code 306 to the AV 390 (512). For example, the mobile computing device 300 can authenticate the initial flash code 395 based on flash code data received from a code generator 125 of the backend transport facilitation system 399 when the match was made between the rider and the selected AV 390. Once authenticated, the mobile computing device 300 can generate and output the return flash code 306 using, for example, the camera light of the camera 302. Based on an authentication of the return flash code 306 by the AV 390, the mobile computing device 300 can establish a wireless connection with the AV 390 (514). The wireless connection can comprise one of a Wi-Fi, WiGig, Bluetooth, or cellular radio connection, and may be based on protocol availability on the mobile computing device 300.

According to some implementations, the mobile computing device 300 may generate a control interface 414 (or AV configuration interface 344) to enable the rider to control various AV components (516). The mobile computing device 300 can then transmit control commands to the AV 390 over the wireless connection based on user inputs 318 on the control interface 414 (518). Such control commands can be executed to cause a control system of the AV 390 to make adjustments to or otherwise configure, for example, the audio system (519), the display system (521), the climate control system (523), the seat adjustment system (527), available network services on the AV 390 or provided via a user account with the transport facilitation system 399 (525), and various other adjustable components of the AV 390.

In certain aspects, the network services on the AV 390 can be correlated to a selected set top level preferences on the control interface 414 and can require additional authorization for the user. For example, when the user selects a particular profile (e.g., a work profile), the AV 410 can utilize the secure handshake to authenticate the user and configure the AV 410 according to the work profile settings. These settings can include access to network features such as conferencing access, personalized home page settings, browser settings, interior lighting settings, audio settings, and the like. Such settings can be configured by the AV 410 in response to the user selecting a stored profile and prior to the user entering the AV 410.

As the ride comes to a conclusion, the mobile computing device 300 can detect user egress from the AV 410 and terminate the designated application 402 (528). Upon exiting, the AV 410 can reset the AV settings and configuration to a predetermined default.

FIG. 5B is a flow chart describing an example method of performing a flash code handshake by an AV, as described herein. In the below description of FIG. 5B, reference may be made to reference characters representing like features describing in connection with FIGS. 1 through 4B. Furthermore, the method described with respect to FIG. 5B may be performed by an example AV 200 as shown and described in connection with FIG. 2. Referring to FIG. 5B, the AV 200 can receive an invitation 213 to service a pick-up request from a backend transport facilitation system 290 (530), and, in response, transmit an acknowledgement 218 to service the request (534). In various implementations, the AV 200 can identify the pick-up location (e.g., in the invitation 213) to rendezvous with the requesting rider (532).

According to some aspects, when the AV 200 is within a certain proximity to the pick-up location (e.g., a predetermined distance or time), the AV 200 can initiate a flash code via a flash element 266 of the AV 200, such as a light bar mounted to be viewed from a forward exterior of the AV 200 (536). After outputting the flash code, the AV 200 can detect a return flash code 299 from the mobile computing device 280 of the rider (538). The AV 200 can authenticate the return flash code 299 based on flash code data 217 received from the backend transport facilitation system 290 when the pairing between the AV 200 and the rider was established (540).

In some examples, the AV 200 can further receive credential data 289 from the mobile computing device 280 of the rider via an NFC interface 275 (542). In such examples, the AV 200 can further authenticate the credential data 289 against, for example, account information indicating user data from the transport facilitation system 290 (544). In one example, the account information can further indicate or otherwise unlock certain services and features of the AV 200 (e.g., conferencing or other network and/or computational services). Furthermore, in certain aspects, upon authenticating the credential information 289, the AV 200 can unlock and open a passenger door to allow the correct rider to enter the AV 200 (546).

According to examples described herein, the AV 200 can establish a secure wireless connection with the mobile computing device 280 of the rider (548). The wireless connection can comprise, for example, a Wi-Fi (549), WiGig (551), a Bluetooth (553), or other network protocol, and may be selected based on availability on the mobile computing device 280. The wireless connection can trigger a control interface 414 to be generated on the mobile computing device 280 to enable the rider to input various adjustments to and interact with the components of the AV 200. Thus, the AV 200 can receive control commands 274 from the mobile computing device 280 to make adjustments, configure, and/or interact with the various components of the AV 200. For example, the control commands 274 can comprise commands to configure, set-up, or interact with an audio system of the AV 200 (555). Such commands can cause the AV 200 to change radio station channels, and/or adjust an output volume or other audio settings of the audio system.

As another example, the control commands 274 can comprise commands to interact with a display system of the AV 200 (557). Such commands can cause the AV 200 to display content, provide entertainment features, provide a video conferencing feature, and the like. Control commands 274 can further cause the AV 200 to make adjustments to a seat system (561). For example, the control interface 414 can enable the user to adjust a thigh extension length, a seatback tilt angle, a forward-aft position, a lumbar support feature, a headrest angle or height, and the like. Control commands 274 can further cause the AV 200 to facilitate various network services for the rider (559), such as gaming, virtual and/or augmented reality, application-based services, internet access, and the like. Further, the control commands 274 can further cause the AV 200 to adjust a climate control system of the AV 200 (563), to adjust temperature, fan speed, airflow output, and the like. Still further, the control commands 274 can cause the AV 200 to configure or adjust other components of the AV (565), such as the windows, mirrors, operational mode, door locks, interior lighting, etc.

Accordingly, the AV 200 can execute the control commands 274 on the respective components of the AV 200 to make the adjustments based on the user inputs on the control interface 414 (552). In the meantime, the AV 200 can also navigate and autonomously drive the rider to the destination for drop-off (554). Upon arrival at the destination, the AV 200 can detect rider egress from the AV 200 and terminate the wireless connection accordingly (556). Detection of rider egress can be performed by the AV 200 in any number of ways. In some aspects, the AV 200 can monitor the AV interior to continuously or near-continuously confirm that the rider is present. Certain occupancy sensing functions performed by the AV 200 can include one or more interior cameras, seat pressure sensors, location-based sensors (e.g., accessing GPS on the user's device), door sensors, and/or scanners to scan the interior for occupancy or facial recognition. In one example, the confirmation of rider occupancy can comprise a second authentication on top of the flash code handshake. Thus, in some examples, the AV 200 can continuously or periodically confirm that the correct rider is in the AV 200 order to, for example, provide access to third party services. Upon detecting rider egress, the AV 200 can terminate the connection and reset the configuration settings to, for example, a default set of settings.

Hardware Diagrams

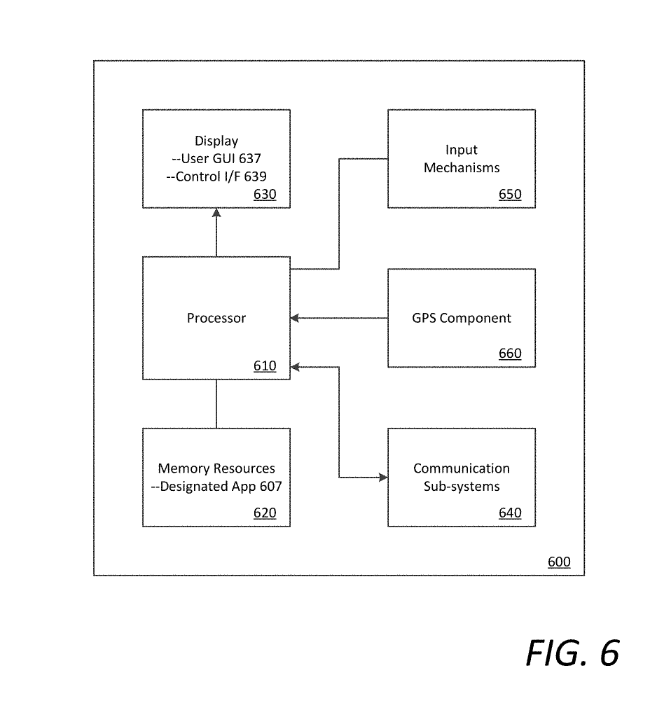

FIG. 6 is a block diagram that illustrates a mobile computing device upon which examples described herein may be implemented. In one example, a mobile computing device 600 may correspond to, for example, a cellular communication device (e.g., feature phone, smartphone, VR or AR headset, etc.) that is capable of telephony, messaging, and/or data services. In variations, the mobile computing device 600 can correspond to, for example, a tablet or wearable computing device. Still further, the mobile computing device 600 can be distributed amongst multiple portable devices of requesting users.

In an example of FIG. 6, the computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), and one or more location detection mechanisms (e.g., GPS component 660). In one example, at least one of the communication sub-systems 640 sends and receives cellular data over data channels and voice channels.

A requesting user of the network service can operate the mobile computing device 600 to transmit a pick-up request including a pick-up location. The memory resources 620 can store a designated user application 607 to link the requesting user with the network service to facilitate a pick-up. Execution of the designated application 607 by the processor 610 can cause a user GUI 637 to be generated on the display 630. User interaction with the user GUI 637 can enable the user to transmit a pick-up request in connection with the network service, which enables AVs or drivers to accept an invitation to service the pick-up request. Furthermore, upon establishing a wireless connection with an AV, the processor 610, in executing the designated application 607, can generate a control interface 639 on the display 630 to enable the user to various the various components of the AV, as described herein.

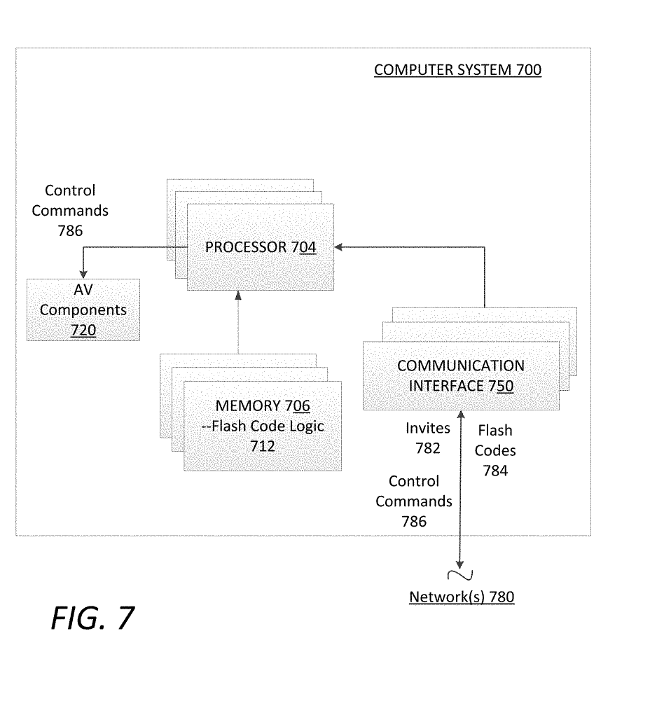

FIG. 7 is a block diagram illustrating a computer system upon which example AV processing systems described herein may be implemented. The computer system 700 can be implemented using one or more processors 704, and one or more memory resources 706. In the context of FIG. 2, the control system 220 can be implemented using one or more components of the computer system 700 shown in FIG. 7.

According to some examples, the computer system 700 may be implemented within an AV with software and hardware resources such as described with examples of FIGS. 1 through 4B. In an example shown, the computer system 700 can be distributed spatially into various regions of the AV, with various aspects integrated with other components of the AV itself. For example, the processors 704 and/or memory resources 706 can be provided in the trunk of the AV. The various processing resources 704 of the computer system 700 can also execute flash code logic 712 using microprocessors or integrated circuits. In some examples, the flash code logic 712 can be executed by the processing resources 704 or using field-programmable gate arrays (FPGAs).

In an example of FIG. 7, the computer system 700 can include a communication interface 750 to communicate with a transport facilitation system and a rider device over a number of networks 780.

The memory resources 706 can include, for example, main memory, a read-only memory (ROM), storage device, and cache resources. The main memory of memory resources 706 can include random access memory (RAM) or other dynamic storage device, for storing information and instructions which are executable by the processors 704. The processors 704 can execute instructions for processing information stored with the main memory of the memory resources 706. The main memory 706 can also store temporary variables or other intermediate information which can be used during execution of instructions by one or more of the processors 704. The memory resources 706 can also include ROM or other static storage device for storing static information and instructions for one or more of the processors 704. The memory resources 706 can also include other forms of memory devices and components, such as a magnetic disk or optical disk, for purpose of storing information and instructions for use by one or more of the processors 704.

According to some examples, the memory 706 may store a plurality of software instructions including, for example, flash code logic 712. The flash code logic 712 may be executed by one or more of the processors 704 in order to implement functionality such as described with respect to the FIGS. 1 through 4B.

In certain examples, the computer system 700 can receive transport invitations 782 and flash codes 784 over the communication interface 750 from the transport facilitation system via the network(s) 780. Additionally or alternatively, the computer system 700 can receive control commands 786 over the network(s) 780 from the rider's mobile device, where the control commands 786 correspond to user inputs to adjust, configure, and/or interact with the various AV components 720. In response, the processing resources 704 can execute the control commands 786 on the respective AV components 720, as described herein.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. An autonomous vehicle (AV) comprising:
a communications array to transmit and receive communications from a transport facilitation system;
a sensor array to generate sensor data corresponding to a situational environment of the AV;
an acceleration, steering, and braking system;
a control system to process the sensor data to autonomously control the acceleration, steering, and braking system to destinations received from the transport facilitation system;
a set of configurable components; and
a rider interaction system comprising:
a lighting element;
one or more processors; and
one or more memory resources storing instructions that, when executed by the one or more processors, cause the rider interaction system to:
identify a pick-up location in which the AV will rendezvous with a requesting rider;
when the AV is within a proximity to the pick-up location, initiate a flash sequence using the lighting element to enable a mobile computing device of the requesting user to identify the AV; and
using one or more sensors of the sensor array, monitor the situational environment for a return flash sequence from the mobile computing device.

2. The AV of claim 1, further comprising:
a wireless communications interface;
wherein the executed instructions further cause the rider interaction system to:
detect a return flash sequence from the mobile computing device;
authenticate the return flash sequence; and
based on authenticating the return flash sequence, establishing a wireless connection with the mobile computing device using the wireless communications interface.

3. The AV of claim 2, wherein the wireless connection comprises one of a Bluetooth connection, a Wi-Fi connection, or a WiGig connection.

4. The AV of claim 2, wherein the wireless connection enables the requesting rider to control the set of configurable components.

5. The AV of claim 1, further comprising:
a wireless communications interface; and
a near-field communications (NFC) interface;
wherein the executed instructions further cause the rider interaction system to:
receive a validated credential set from the transport facilitation system, the validated credential set identifying at least one of the requesting user or the mobile computing device;
receive, via the NFC interface, credentials from the mobile computing device;
verify the credentials against the validate credential set.

6. The AV of claim 5, wherein the executed instructions further cause the rider interaction system to:
in response to verifying the credentials, establish a wireless connection with the mobile computing device.

7. The AV of claim 6, wherein the wireless connection enables the requesting rider to control the set of configurable components.

8. The AV of claim 7, wherein the set of configurable components comprises one or more of an adjustable seat, an audio system, a display system, a network service, a locking mechanism, or a climate control system.

9. The AV of claim 5, wherein the executed instructions further cause the rider interaction system to:
in response to verifying the credentials, unlock a door locking mechanism of the AV to enable the requesting user to enter the AV.

10. A mobile computing device comprising:
a camera device;
a display screen;
one or more processors; and
one or more memory resources storing instructions that, when executed by the one or more processors, cause the mobile computing device to:
in response to a user input via a designated application, transmit a pick-up request to a transport facilitation system, the pick-up request indicating a pick-up location for a requesting rider;
receive information corresponding to an autonomous vehicle (AV) en route to the pick-up location to service the pick-up request;
when the AV is within a proximity from the pick-up location, generate a prompt on the display screen, the prompt instructing the requesting rider to point the camera device towards the AV; and
detect, via the camera device, a flash sequence outputted from the AV, the flash sequence being used to indicate that the AV has been matched to the pick-up request by the transport facilitation system.

11. The mobile computing device of claim 10, wherein the executed instructions further cause the mobile computing device to:
in response to receiving the flash sequence, generate a response flash sequence, via a lighting element of the camera device, to enable the AV to authenticate the mobile computing device.

12. The mobile computing device of claim 11, wherein the executed instructions further cause the mobile computing device to:
based on the AV authenticating the mobile computing device, establish a wireless connection with the AV; and
generate, on the display screen, a control interface to enable the requesting user to operate a set of configurable components of the AV.

13. The mobile computing device of claim 12, wherein the set of configurable components comprise at least one of a climate control system, one or more controllable seats, mirrors, windows, a sunroof, an audio system, an AV display system, or interior lighting elements.

14. The mobile computing device of claim 10, wherein the executed instructions further cause the mobile computing device to:
in response to receiving the flash sequence, generate an indication on the display screen that the AV is matched with the requesting rider.

15. The mobile computing device of claim 14, wherein the indication comprises a highlighting feature that highlights the AV on a live video displayed on the display screen.

16. The mobile computing device of claim 1, further comprising:
a near-field communications (NFC) interface;
wherein the executed instructions further cause the mobile computing device to:
detect a corresponding NFC interface on the AV;
establish an NFC link between the NFC interface and the corresponding NFC interface; and
in response to detecting the corresponding NFC interface, transmit a set of credentials to the AV for authentication.

17. A non-transitory computer-readable medium storing instructions that, when executed by one or more processors of a mobile computing device, cause the mobile computing device to:
in response to a user input via a designated application, transmit a pick-up request to a transport facilitation system, the pick-up request indicating a pick-up location for a requesting rider;
receive information corresponding to an autonomous vehicle (AV) en route to the pick-up location to service the pick-up request;
when the AV is within a proximity from the pick-up location, generate a prompt on a display screen of the mobile computing device, the prompt instructing the requesting rider to point a camera device of the mobile computing device towards the AV; and
detect, via the camera device, a flash sequence from the AV, the flash sequence being used to indicate that the AV has been matched to the pick-up request by the transport facilitation system.

18. The non-transitory computer-readable medium of claim 17, wherein the executed instructions further cause the mobile computing device to:
in response to receiving the flash sequence, generate a response flash sequence, via a lighting element of the mobile computing device, to enable the AV to authenticate the mobile computing device.

19. The non-transitory computer-readable medium of claim 18, wherein the executed instructions further cause the mobile computing device to:
based on the AV authenticating the mobile computing device, establish a wireless connection with the AV; and
generate, on the display screen, a control interface to enable the requesting user to operate a set of configurable components of the AV.

20. The non-transitory computer-readable medium of claim 19, wherein the set of configurable components comprise at least one of a climate control system, one or more controllable seats, mirrors, windows, a sunroof, an audio system, an AV display system, or interior lighting elements.
